(19) United States
(12) Patent Application Publication
(10) Pub. No.: US 2026/0164258 A1
(43) Pub. Date: Jun. 11, 2026

(54) Artificial Intelligence (AI) Network Enhancement with Peer to Peer Links

(71) Applicant: Apple Inc., Cupertino, CA (US)

(72) Inventors: Peng Cheng, Beijing (CN); Onur Sahin, San Diego, CA (US); Oner Orhan, San Jose, CA (US); Ralf Rossbach, Munich (DE); Ahmed M. Soliman, Munich (DE); Haijing Hu, Los Gatos, CA (US); Arnab Roy, San Diego, CA (US)

(21) Appl. No.: 18/849,462

(22) PCT Filed: Sep. 27, 2023
(86) PCT No.: PCT/CN2023/122363

§ 371 Date: Sep. 20, 2024

(51) Int. Cl. H04W 24/02; H04L 41/16; H04W 76/14; H04W 88/06

(52) U.S. Cl. CPC H04W 24/02; H04L 41/16; H04W 76/14; H04W 88/06

(57) ABSTRACT

An artificial intelligence (AI) edge user equipment (AEU) may establish one or more peer to peer connections (P2P) with a UE to form connected UEs via a discovery procedure; transmit, to a base station (BS) in a first control message, capability information of each of the one or more connected UEs; transmit, via the one or more P2P connections, configuration information to each of the one or more connected UEs; receive, via the one or more P2P connections, data from each of the one or more connected UEs based on the configuration information; and transmit, to the BS via a third control message, the collected data from one or more of the one or more connected UEs for one or more artificial intelligence (AI) models.

### FIELD

Embodiments of the invention relate to wireless communications, including apparatuses, systems, and methods for 6G artificial intelligence (AI) network enhancement with peer to peer links, including systems, methods, and mechanisms.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities. Additionally, there exist numerous different wireless communication technologies and standards.

Long Term Evolution (LTE), also referred to as the Evolved Universal Terrestrial Radio Access Network (E-UTRAN), has been the technology of choice for the majority of wireless network operators worldwide, providing mobile broadband data and high-speed Internet access to their subscriber base. LTE was first proposed as an upgrade to the fourth generation (4G) of the Third Generation Partnership Project (3GPP) in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of the 3GPP Fifth Generation New Radio (5G NR) was standardized. 5th generation mobile networks or 5th generation wireless systems, referred to as 3GPP NR (otherwise known as 5G-NR or NR-5G for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

5G-NR provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

One aspect of wireless communication systems, e.g., systems for NR cellular wireless communications, is the transmission and measurement of signals that can be used to train and enhance the wireless communication systems through the use of artificial intelligence. In 5G-NR, Artificial Intelligence (AI) models can be used to predict patterns and reduce the amount of overhead used to communicate and measure signals. However, for wireless devices that are not connected to a cellular network, the ability to obtain enhancements through the use of artificial intelligence models is limited.

### SUMMARY

Embodiments relate to wireless communications, including apparatuses, systems, and methods for providing artificial intelligence (AI) network enhancements with a peer to peer connections.

In some embodiments, an artificial intelligence (AI) edge user equipment (AEU) may establish one or more peer to peer connections with one or more UEs to form connected UEs via a discovery procedure; transmit, to a base station (BS) in a first control message, capability information of each of the one or more connected UEs, wherein the capability information comprises one or more of a UE identifier (ID), an indication of whether each connected UE is out-of-coverage from the BS, an first acknowledgement indicating an approval or disapproval to share data with the AEU, or a second acknowledgement indicating an approval or disapproval to collaborate with the AEU; receive, from the BS in a second control message, configuration information for reporting data from the one or more connected UEs; transmit, via the one or more peer to peer connections, the configuration information to each of the one or more connected UEs; receive, via the one or more peer to peer connections, data from each of the one or more connected UEs based on the configuration information; and transmit, to the BS via a third control message, the collected data from each of the one or more connected UEs for one or more artificial intelligence (AI) models

Other embodiments relate to an apparatus is disclosed of an artificial intelligence (AI) edge user equipment (AEU) configured to enhance AI network performance. The apparatus comprises one or more processors coupled to a memory. The one or more processors are configured to establish one or more peer to peer connections with one or more user equipments (UEs) to form connected UEs via a discovery procedure. The AEU may transmit, to a base station (BS) in a first control message, capability information of each connected UE, where the capability information comprises one or more of a UE identifier (ID), an indication of whether each UE is in or out of coverage from the BS, a first acknowledgement indicating willingness to share data with the AEU, or a second acknowledgement indicating willingness to collaborate with the AEU. The AEU may receive configuration information from the BS in a second control message for reporting data from the connected UEs. The AEU may transmit the configuration information to each connected UE via the peer to peer connections. The AEU may receive data from each connected UE via the peer to peer connections based on the configuration. Finally, the AEU may transmit the collected data from each connected UE to the BS in a third control message for one or more AI models.

In the discovery procedure, the AEU receives solicitation messages from UEs requesting AI/ML offloading with UE capabilities, decodes the capabilities, measures received signal strength, determines if it exceeds a threshold, and selects UEs for establishing peer to peer connections based on the threshold. The peer to peer connections include various radio access technologies such as wireless local area network (WLAN) direct connections. Using the peer to peer connection, the first control message can indicate the connected UEs and their connection types. The second control message contains transparent containers with configurations and AI models. The configurations can be received via various signaling. AI models for local training/inference may also be received. The third message contains transparent containers with the data, training results, inference results, aggregated results, and final aggregated inference outcome.

The techniques described herein may be implemented in and/or used with a number of different types of devices, including but not limited to base stations, access points, cellular phones, tablet computers, wearable computing devices, portable media players, vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6A illustrates an example of a 5G network architecture that incorporates both 3GPP (e.g., cellular) and non-3GPP (e.g., non-cellular) access to the 5G CN, according to some embodiments.

FIG. 6B illustrates an example of a 5G network architecture that incorporates both dual 3GPP (e.g., LTE and 5G NR) access and non-3GPP access to the 5G CN, according to some embodiments.

FIG. 7 illustrates an example of a baseband processor architecture for a UE, according to some embodiments.

FIG. 8 illustrates an example of a device in accordance with some embodiments.

FIG. 9 illustrates an example baseband circuitry in accordance with some embodiments.

FIG. 10 illustrates an example of architecture of a system supporting artificial intelligent including O-RAN in accordance with some embodiments.

FIG. 11A-C illustrate examples of AI/ML edge user equipment (AEU) deployed to enhance AI/ML performance using sidelink connections.

FIG. 12 illustrates an example of signaling for enabling AI/ML network enhancement with sidelink in accordance with some embodiments.

FIG. 13 illustrates an example timing diagram signaling between a user equipment (UE), AI/ML edge user equipment (AEU), and base station (BS) for supporting 6G AI/ML network enhancement with sidelink according to some embodiments.

FIG. 14 illustrates an example of system architecture supporting AI/ML network enhancement with sidelink in accordance with some embodiments.

FIG. 15 illustrates an example of an AI/ML edge user equipment (AEU) selection procedure that supports AI/ML network enhancement using sidelinks accordance with some embodiments.

FIG. 16 illustrates an example of a discovery message for multi-radio, multi-vendor AI/ML aware discovery in accordance with some embodiments.

FIG. 17 performing an AEU selection procedure to support multi-radio, multi-vendor AI/ML aware discovery according to some embodiments.

FIG. 18 performing an AEU selection procedure to support multi-radio, multi-vendor AI/ML aware discovery from an AEU perspective according to some embodiments according to some embodiments.

FIG. 19 illustrates an example of a method for providing enhanced AI/ML performance using sidelink using AI/ML edge user equipment (AEU) according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

The following is a glossary of terms used in this disclosure: Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above. As used herein, the term “one or more processors” can refer to either baseband processing circuitry 804 for a baseband processor (e.g. 804A-D) or an application processor (e.g. 204).

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by the Third Generation Partnership Project (3GPP) standards. These accesses include, but are not limited to, GSM/GPRS, LTE, LTE-A, and/or 5G NR, 6G and beyond. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system can update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as used by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Encoding—refers to the baseband circuitry (e.g. 804) that is used to encode data. The data may also be modulated and prepared, as described herein, for output from the baseband circuitry for transmission.

Decoding—refers to the baseband circuitry (e.g. 804) that is used to decode data. The data may also be demodulated and prepared for decoding, as described herein, after being received.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

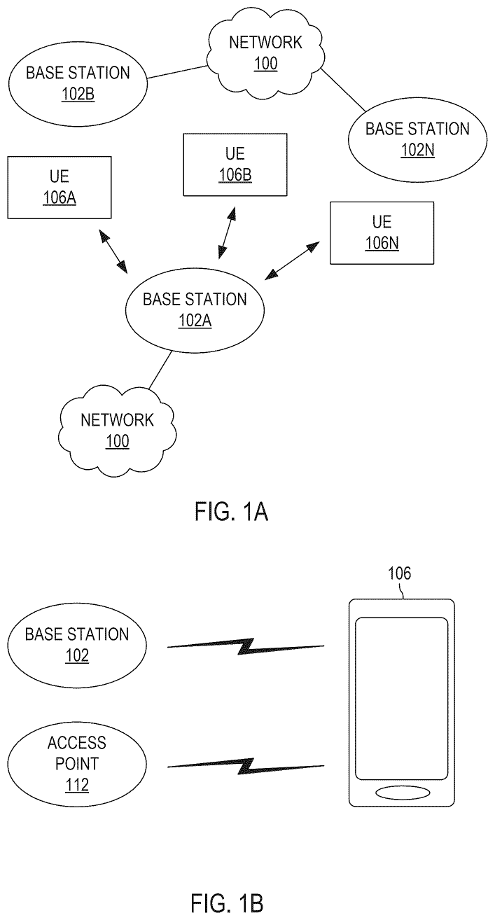

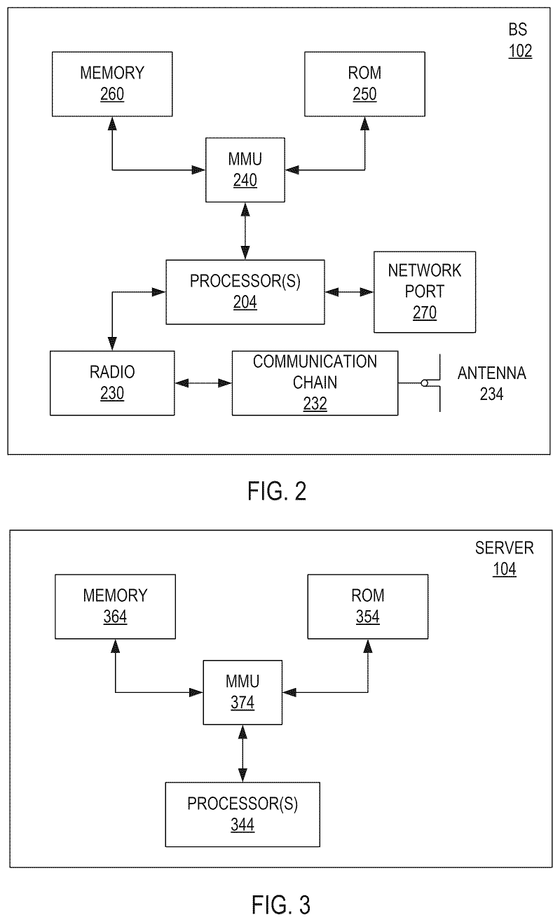

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP 2 CDMA2000 (e.g., 1xRTT, 1xEV-DO, HRPD, eHRPD), etc. Note that if the base station 102A is implemented in the context of LTE (E-UTRAN), it may alternately be referred to as an ‘eNodeB’ or ‘eNB’. Note that if the base station 102A is implemented in the context of 5G NR, it may alternately be referred to as ‘gNodeB’ or ‘gNB’. Note that if the base stations 102A-N are implemented in the context of 6G, it may simply be referred to as a base station or BS.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards. A managed network (or cell) can include a base station (or evolved nodeB (eNB) or next generation NodeB (gNB) or access point) in signal communication with a plurality of user equipment (UEs) (or user nodes or terminals) and operationally connected to a core network (CN) which can be configured to provide non-radio tasks, such as administration, and is typically connected to a larger network such as the Internet.

Thus, while base station 102A may act as a “serving cell” for UEs 106A-N as illustrated in FIG. 1A, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”, or a base station configured to communicate in a sixth generation (6G) radio network. In some embodiments, the BS 102 may be connected to a legacy evolved packet core (EPC) network and/or to a NR core (NRC) network. In addition, a BS cell may include one or more transition and reception points (TRPs). In addition, a UE capable of operating according to 5G NR may be connected to one or more TRPs within one or more BSs 102N.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP 2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE (E-UTRAN) or 5G NR (or LTE or 1xRTT or LTE or GSM), and separate radios for communicating using each of Wi-Fi and Bluetooth. Other configurations are also possible.

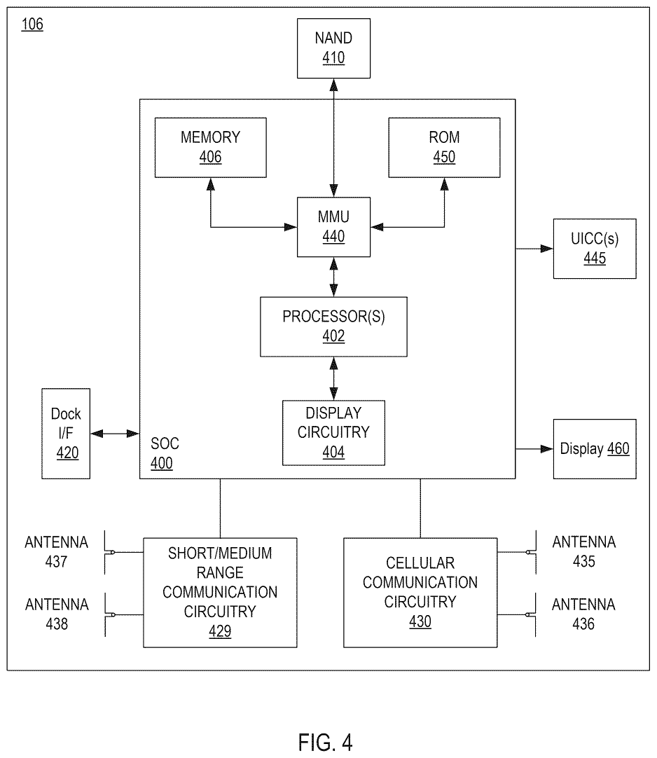

### FIG. 2: Block Diagram of a Base Station

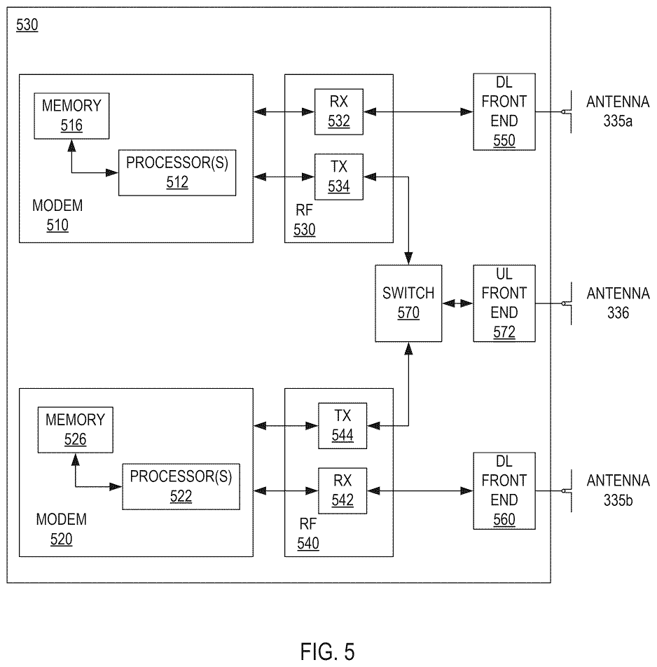

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more BSs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

The base stations 102N can communicate with the UEs 106N via wireless links, which may be implemented as any suitable type of wireless link. The wireless links can include a downlink of data and control information communicated from the base stations 102N to the UEs 106N, an uplink of other data and control information communicated from the UEs 106N to the BSs 102N, or both. The wireless links may include one or more wireless links or bearers implemented using any suitable communication protocol or standard, or combination of communication protocols or standards such as 3GPP LTE, Fifth Generation New Radio (5G NR), sixth generation (6G), and so forth. Multiple wireless links may be aggregated in a carrier aggregation to provide a higher data rate for the UEs 106N. Multiple wireless links from multiple BSs 102N may be configured for Coordinated Multipoint (COMP) communication with the UEs 106N. Additionally, multiple wireless links may be configured for single-radio access technology (RAT) (single-RAT) dual connectivity (single-RAT-DC) or multi-RAT dual connectivity (MR-DC).

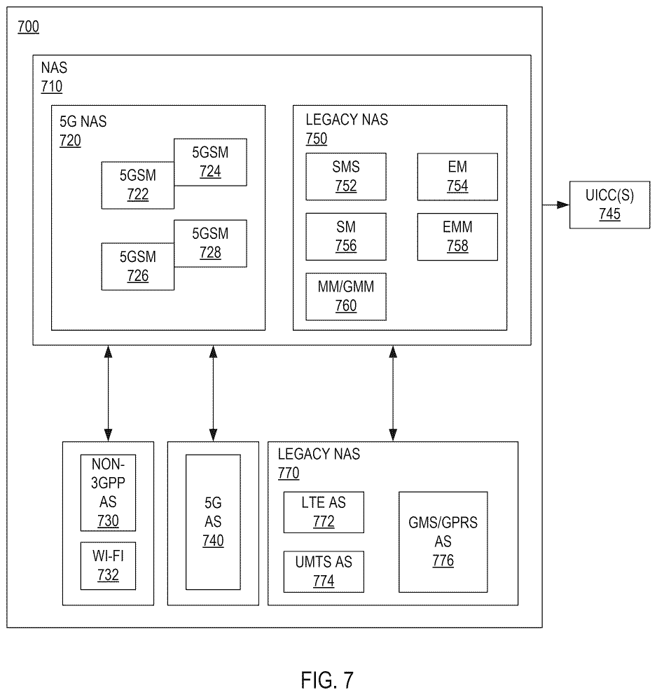

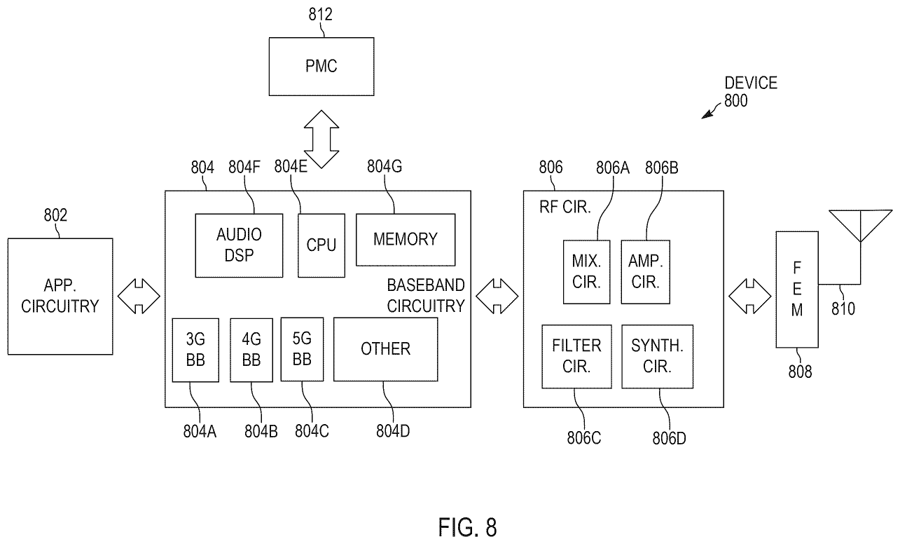

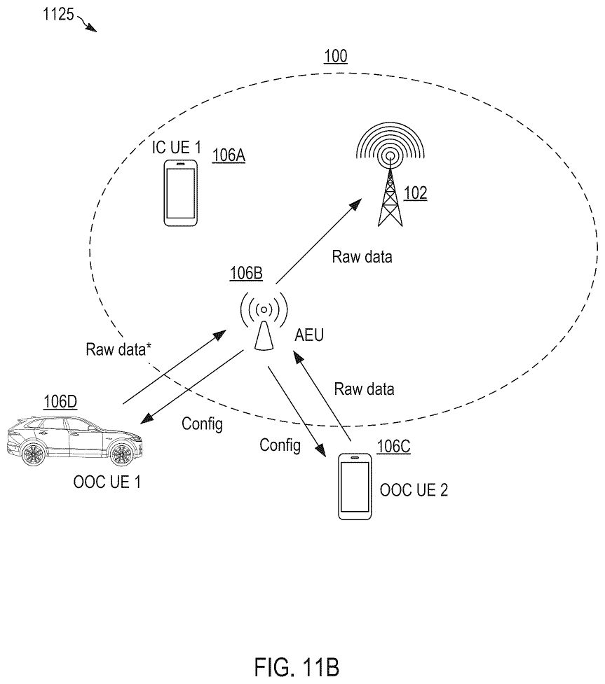

The BSs 102N can be collectively a Radio Access Network 100 (RAN, Evolved Universal Terrestrial Radio Access Network, E-UTRAN, 5G NR RAN or NR RAN, 6G RAN). The BSs 102N in the RAN 100 can be connected to a core network, such as a Fifth Generation Core (5GC) or 6G core network (e.g. 1004, FIG. 10). The base stations 102N may connect to a core network 1004 via an NG2 interface (or a similar 6G interface) for control-plane signaling and via an NG 3 interface (or a similar 6G interface) for user-plane data communications. In addition to connections to core networks, base stations 102N may communicate with each other via an Xn Application Protocol (XnAP), to exchange user-plane and control-plane data. The UEs 106N may also connect, via the core network, to public networks, such as the Internet 600 (FIG. 6).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102 and UE devices 106 access to network functions, e.g., as further described herein.

In some embodiments, the server 104 may be part of a radio access network, such as a 4G EUTRAN, a 5G New Radio (5G NR) radio access network, or a 6G RAN. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

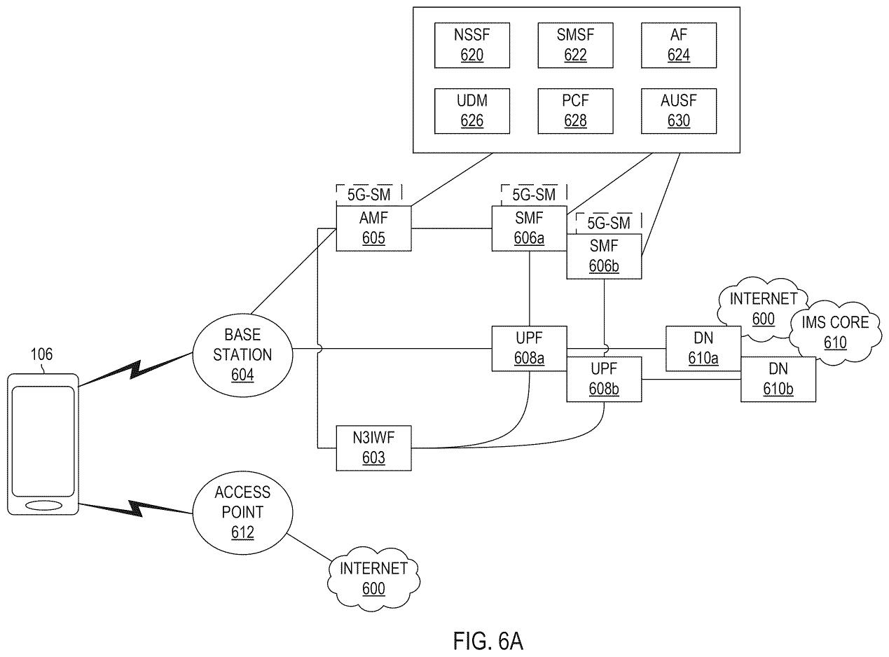

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 6G, 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet. The communications device 106 can be configured for direct wireless networking between UEs, such as Wi-Fi direct.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR or 6G). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, or 6G and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMS may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 support a second RAT such as 5G NR or 6G. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VOLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for AI based CSI feedback with CSI prediction, including systems, methods, and mechanisms for a UE to indicate a predicted CSI report, network configuration of CSI feedback, UE PMI report format, and AI model life cycle management, e.g., in 5G NR systems, 6G systems and beyond, as further described herein.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

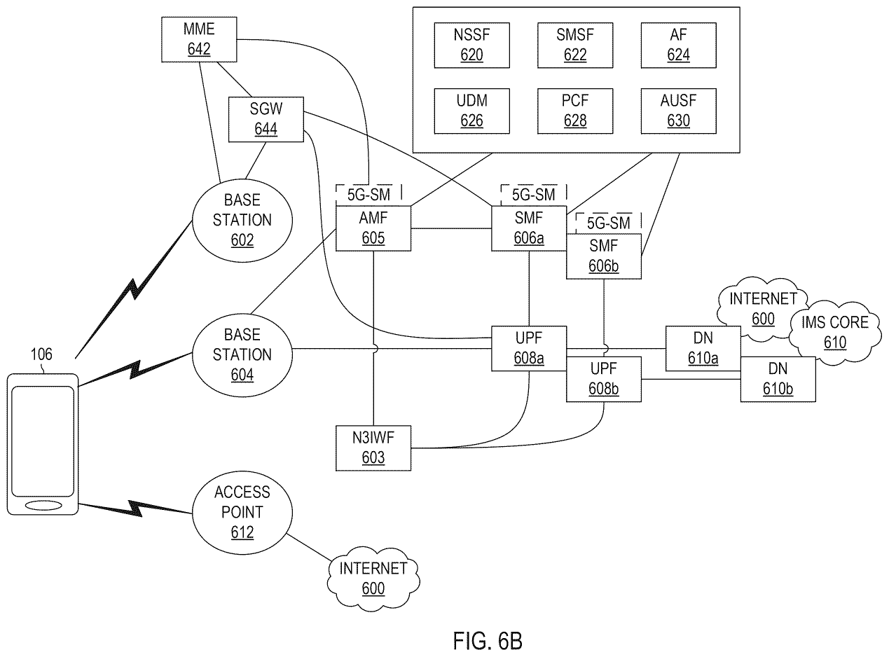

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR or 6G). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR or 6G.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

In some embodiments, the cellular communication circuitry 530 may be configured to perform methods for AI based CSI feedback with CSI prediction, including systems, methods, and mechanisms for a UE to indicate a predicted CSI report, network configuration of CSI feedback, UE PMI report format, and AI model life cycle management, e.g., in 5G NR systems, 6G systems and beyond, as further described herein.

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for AI based CSI feedback with CSI prediction, including systems, methods, and mechanisms for a UE to indicate a predicted CSI report, network configuration of CSI feedback, UE PMI report format, and AI model life cycle management, e.g., in 5G NR systems, 6G systems and beyond, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

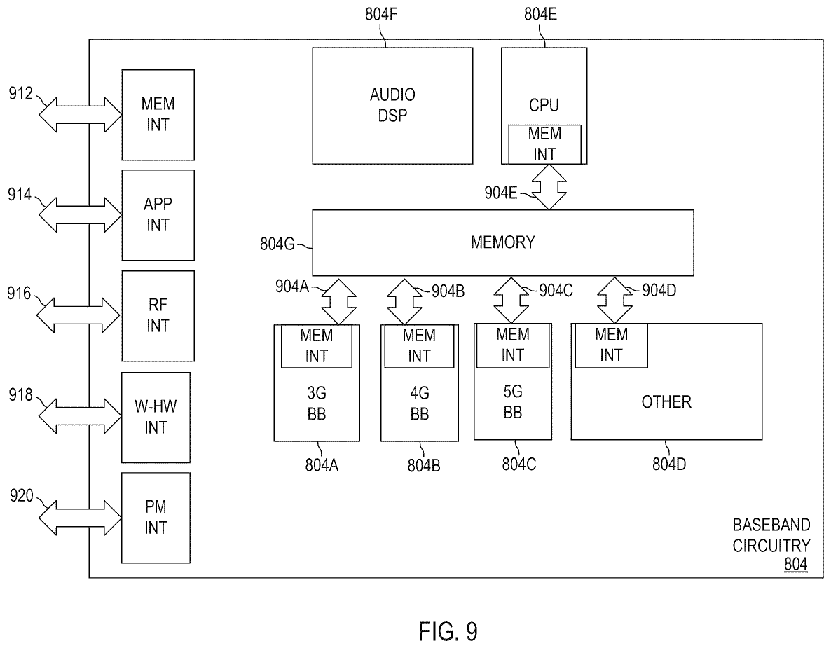

### FIGS. 6A, 6B and 7: 5G Core Network Architecture—Interworking With Wi-Fi

In some embodiments, a 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 6A illustrates an example of a 5G network architecture that incorporates both 3GPP (e.g., cellular) and non-3GPP (e.g., non-cellular) access to the 5G CN, according to some embodiments. As shown, a user equipment device (e.g., such as UE 106) may access the CN through both a radio access network (RAN, e.g., such as BS 604, which may be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the UE 106. In addition, the RAN (e.g., BS 604) may also have a connection to the AMF 605. Thus, the 5G CN may support unified authentication over both connections as well as allow simultaneous registration for UE 106 access via both BS 604 and AP 612. As shown, the AMF 605 may include one or more functional entities associated with the 5G CN (e.g., network slice selection function (NSSF) 620, short message service function (SMSF) 622, application function (AF) 624, unified data management (UDM) 626, policy control function (PCF) 628, and/or authentication server function (AUSF) 630). Note that these functional entities may also be supported by a session management function (SMF) 606a and an SMF 606b of the 5G CN. The AMF 605 may be connected to (or in communication with) the SMF 606a. Further, the BS 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

FIG. 6B illustrates an example of a 5G network architecture that incorporates both dual 3GPP (e.g., LTE and 5G NR) access and non-3GPP access to the 5G CN, according to some embodiments. As shown, a user equipment device (e.g., such as UE 106) may access the 5G CN through both a radio access network (RAN, e.g., such as BS 604 or eNB 602, which may be a base station 102) and an access point, such as AP 612. The AP 612 may include a connection to the Internet 600 as well as a connection to the N3IWF 603 network entity. The N3IWF may include a connection to the AMF 605 of the 5G CN. The AMF 605 may include an instance of the 5G MM function associated with the UE 106. In addition, the RAN (e.g., BS 604) may also have a connection to the AMF 605. Thus, the 5G CN may support unified authentication over both connections as well as allow simultaneous registration for UE 106 access via both BS 604 and AP 612. In addition, the 5G CN may support dual-registration of the UE on both a legacy network (e.g., LTE via eNB 602) and a 5G network (e.g., via BS 604). As shown, the eNB 602 may have connections to a mobility management entity (MME) 642 and a serving gateway (SGW) 644. The MME 642 may have connections to both the SGW 644 and the AMF 605. In addition, the SGW 644 may have connections to both the SMF 606a and the UPF 608a. As shown, the AMF 605 may include one or more functional entities associated with the 5G CN (e.g., NSSF 620, SMSF 622, AF 624, UDM 626, PCF 628, and/or AUSF 630). Note that UDM 626 may also include a home subscriber server (HSS) function and the PCF may also include a policy and charging rules function (PCRF). Note further that these functional entities may also be supported by the SMF 606a and the SMF 606b of the 5G CN. The AMF 605 may be connected to (or in communication with) the SMF 606a. Further, the BS 604 may in communication with (or connected to) the UPF 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and IMS core network 610.

Note that in various embodiments, one or more of the above-described network entities may be configured to perform methods for AI based CSI feedback with CSI prediction, including systems, methods, and mechanisms for a UE to indicate a predicted CSI report, network configuration of CSI feedback, UE PMI report format, and AI model life cycle management, e.g., in 5G NR systems, 6G systems and beyond, e.g., as further described herein.

FIG. 7 illustrates an example of a baseband processor architecture for a UE (e.g., such as UE 106), according to some embodiments. The baseband processor architecture 700 described in FIG. 7 may be implemented on one or more radios (e.g., radios 429 and/or 430 described above) or modems (e.g., modems 510 and/or 520) as described above. As shown, the non-access stratum (NAS) 710 may include a 5G NAS 720 and a legacy NAS 750. The legacy NAS 750 may include a communication connection with a legacy access stratum (AS) 770. The 5G NAS 720 may include communication connections with both a 5G AS 740 and a non-3GPP AS 730 and Wi-Fi AS 732. The 5G NAS 720 may include functional entities associated with both access stratums. Thus, the 5G NAS 720 may include multiple 5G MM entities 726 and 728 and 5G session management (SM) entities 722 and 724. The legacy NAS 750 may include functional entities such as short message service (SMS) entity 752, evolved packet system (EPS) session management (ESM) entity 754, session management (SM) entity 756, EPS mobility management (EMM) entity 758, and mobility management (MM)/ GPRS mobility management (GMM) entity 760. In addition, the legacy AS 770 may include functional entities such as LTE AS 772, UMTS AS 774, and/or GSM/GPRS AS 776.

Thus, the baseband processor architecture 700 allows for a common 5G-NAS for both 5G cellular and non-cellular (e.g., non-3GPP access). The baseband processor architecture 700 can be in communication with one or more UICC(s) 745. Note that as shown, the 5G MM may maintain individual connection management and registration management state machines for each connection. Additionally, a device (e.g., UE 106) may register to a single PLMN (e.g., 5G CN) using 5G cellular access as well as non-cellular access. Further, it may be possible for the device to be in a connected state in one access and an idle state in another access and vice versa. Finally, there may be common 5G-MM procedures (e.g., registration, de-registration, identification, authentication, as so forth) for both accesses.

Note that in various embodiments, one or more of the above-described functional entities of the 5G NAS and/or 5G AS may be configured to perform methods for AI based CSI feedback with CSI prediction, including systems, methods, and mechanisms for a UE to indicate a predicted CSI report, network configuration of CSI feedback, UE PMI report format, and AI model life cycle management, e.g., in 5G NR systems, 6G systems and beyond, e.g., as further described herein.

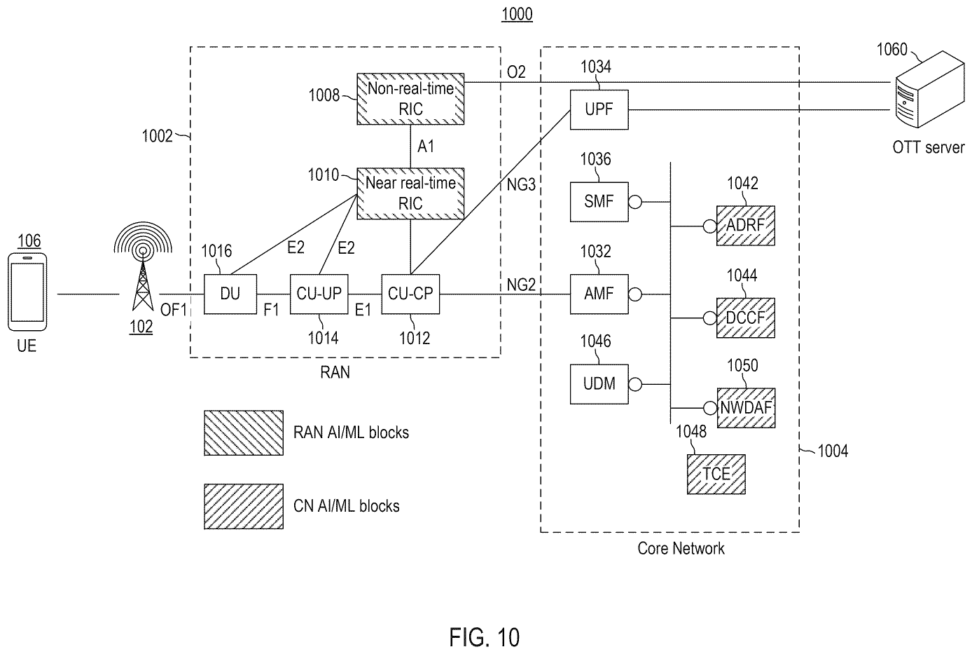

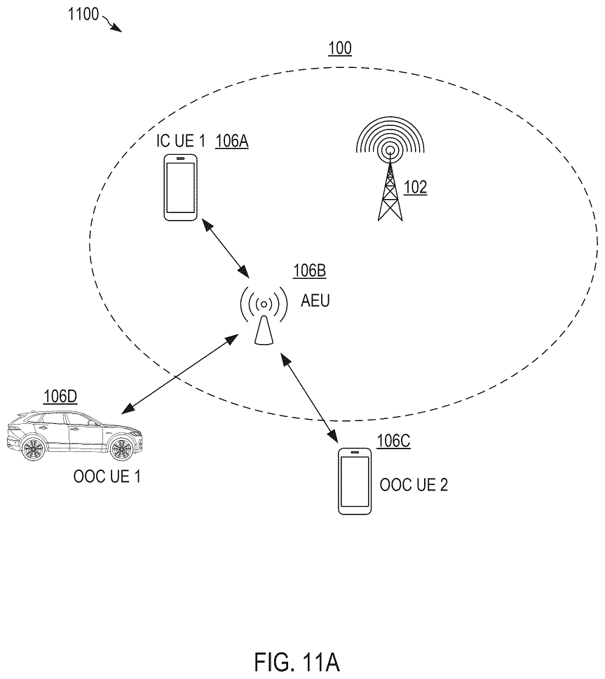

### FIGS. 8 and 9: Baseband Processor Architecture and Interface

FIG. 8 illustrates example components of a device 800 in accordance with some embodiments. In some embodiments, the device 800 may include application circuitry 802, baseband circuitry 804, Radio Frequency (RF) circuitry 806, front-end module (FEM) circuitry 808, one or more antennas 810, and power management circuitry (PMC) 812 coupled together at least as shown. The components of the illustrated device 800 may be included in a UE or a RAN node. In some embodiments, the device 800 may include less elements (e.g., a RAN node may not utilize application circuitry 802, and instead include a processor/controller to process IP data received from an EPC). In some embodiments, the device 800 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 802 may include one or more application processors. For example, the application circuitry 802 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 800. In some embodiments, processors of application circuitry 802 may process IP data packets received from an EPC.

The baseband circuitry 804 may include circuitry such as, but not limited to, one or more single-core or multi-core processors. The baseband circuitry 804 may include one or more baseband processors or control logic to process baseband signals received from a receive signal path of the RF circuitry 806 and to generate baseband signals for a transmit signal path of the RF circuitry 806. Baseband processing circuity 804 may interface with the application circuitry 802 for generation and processing of the baseband signals and for controlling operations of the RF circuitry 806. For example, in some embodiments, the baseband circuitry 804 may include a third generation (3G) baseband processor 804A, a fourth generation (4G) baseband processor 804B, a fifth generation (5G) baseband processor 804C, or other baseband processor(s) 804D for other existing generations, generations in development or to be developed in the future (e.g., second generation (2G), sixth generation (6G), etc.). The baseband circuitry 804 (e.g., one or more of baseband processors 804A-D) may handle various radio control functions that enable communication with one or more radio networks via the RF circuitry 806. In other embodiments, some or all of the functionality of baseband processors 804A-D may be included in modules stored in the memory 804G and executed via a Central Processing Unit (CPU) 804E. The radio control functions may include, but are not limited to, signal modulation/demodulation, encoding/decoding, radio frequency shifting, etc. In some embodiments, modulation/demodulation circuitry of the baseband circuitry 804 may include Fast-Fourier Transform (FFT), precoding, or constellation mapping/demapping functionality. In some embodiments, encoding/decoding circuitry of the baseband circuitry 804 may include convolution, tail-biting convolution, turbo, Viterbi, or Low-Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 804 may include one or more audio digital signal processor(s) (DSP) 804F. The audio DSP(s) 804F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 804 and the application circuitry 802 may be implemented together such as, for example, on a system on a chip (SOC).

In some embodiments, the baseband circuitry 804 may provide for communication compatible with one or more radio technologies. For example, in some embodiments, the baseband circuitry 804 may support communication with an evolved universal terrestrial radio access network (EUTRAN) or other wireless metropolitan area networks (WMAN), a wireless local area network (WLAN), a wireless personal area network (WPAN), and direct communications between UEs. Embodiments in which the baseband circuitry 804 is configured to support radio communications of more than one wireless protocol may be referred to as multi-mode baseband circuitry.

RF circuitry 806 may enable communication with wireless networks using modulated electromagnetic radiation through a non-solid medium. In various embodiments, the RF circuitry 806 may include switches, filters, amplifiers, etc. to facilitate the communication with the wireless network. RF circuitry 806 may include a receive signal path which may include circuitry to down-convert RF signals received from the FEM circuitry 808 and provide baseband signals to the baseband circuitry 804. RF circuitry 806 may also include a transmit signal path which may include circuitry to up-convert baseband signals provided by the baseband circuitry 804 and provide RF output signals to the FEM circuitry 808 for transmission.

In some embodiments, the receive signal path of the RF circuitry 806 may include mixer circuitry 806A, amplifier circuitry 806B and filter circuitry 806C. In some embodiments, the transmit signal path of the RF circuitry 806 may include filter circuitry 806C and mixer circuitry 806A. RF circuitry 806 may also include synthesizer circuitry 806D for synthesizing a frequency for use by the mixer circuitry 806A of the receive signal path and the transmit signal path. In some embodiments, the mixer circuitry 806A of the receive signal path may be configured to down-convert RF signals received from the FEM circuitry 808 based on the synthesized frequency provided by synthesizer circuitry 806D. The amplifier circuitry 806B may be configured to amplify the down-converted signals and the filter circuitry 806C may be a low-pass filter (LPF) or band-pass filter (BPF) configured to remove unwanted signals from the down-converted signals to generate output baseband signals. Output baseband signals may be provided to the baseband circuitry 804 for further processing. In some embodiments, the output baseband signals may be zero-frequency baseband signals, although this is not a necessity. In some embodiments, mixer circuitry 806A of the receive signal path may comprise passive mixers, although the scope of the embodiments is not limited in this respect.

In some embodiments, the mixer circuitry 806A of the transmit signal path may be configured to up-convert input baseband signals based on the synthesized frequency provided by the synthesizer circuitry 806D to generate RF output signals for the FEM circuitry 808. The baseband signals may be provided by the baseband circuitry 804 and may be filtered by filter circuitry 806C.

In some embodiments, the mixer circuitry 806A of the receive signal path and the mixer circuitry 806A of the transmit signal path may include two or more mixers and may be arranged for quadrature downconversion and upconversion, respectively. In some embodiments, the mixer circuitry 806A of the receive signal path and the mixer circuitry 806A of the transmit signal path may include two or more mixers and may be arranged for image rejection (e.g., Hartley image rejection). In some embodiments, the mixer circuitry 806A of the receive signal path and the mixer circuitry 806A may be arranged for direct downconversion and direct upconversion, respectively. In some embodiments, the mixer circuitry 806A of the receive signal path and the mixer circuitry 806A of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 806 may include analog-to-digital converter (ADC) and digital-to-analog converter (DAC) circuitry and the baseband circuitry 804 may include a digital baseband interface to communicate with the RF circuitry 806.

In some dual-mode embodiments, a separate radio IC circuitry may be provided for processing signals for each spectrum, although the scope of the embodiments is not limited in this respect.

In some embodiments, the synthesizer circuitry 806D may be a fractional-N synthesizer or a fractional N/N+1 synthesizer, although the scope of the embodiments is not limited in this respect as other types of frequency synthesizers may be suitable. For example, synthesizer circuitry 806D may be a delta-sigma synthesizer, a frequency multiplier, or a synthesizer comprising a phase-locked loop with a frequency divider.

The synthesizer circuitry 806D may be configured to synthesize an output frequency for use by the mixer circuitry 806A of the RF circuitry 806 based on a frequency input and a divider control input. In some embodiments, the synthesizer circuitry 806D may be a fractional N/N+1 synthesizer.

In some embodiments, frequency input may be provided by a voltage controlled oscillator (VCO), although that is not a requirement. Divider control input may be provided by either the baseband circuitry 804 or the applications processor 802 depending on the desired output frequency. In some embodiments, a divider control input (e.g., N) may be determined from a look-up table based on a channel indicated by the applications processor 802.

Synthesizer circuitry 806D of the RF circuitry 806 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 806D may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 806 may include an IQ/polar converter.

FEM circuitry 808 may include a receive signal path which may include circuitry configured to operate on RF signals received from one or more antennas 810, amplify the received signals and provide the amplified versions of the received signals to the RF circuitry 806 for further processing. FEM circuitry 808 may also include a transmit signal path which may include circuitry configured to amplify signals for transmission provided by the RF circuitry 806 for transmission by one or more of the one or more antennas 810. In various embodiments, the amplification through the transmit or receive signal paths may be done solely in the RF circuitry 806, solely in the FEM 808, or in both the RF circuitry 806 and the FEM 808.

In some embodiments, the FEM circuitry 808 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 806). The transmit signal path of the FEM circuitry 808 may include a power amplifier (PA) to amplify input RF signals (e.g., provided by RF circuitry 806), and one or more filters to generate RF signals for subsequent transmission (e.g., by one or more of the one or more antennas 810).

In some embodiments, the PMC 812 may manage power provided to the baseband circuitry 804. In particular, the PMC 812 may control power-source selection, voltage scaling, battery charging, or DC-to-DC conversion. The PMC 812 may often be included when the device 800 is capable of being powered by a battery, for example, when the device is included in a UE. The PMC 812 may increase the power conversion efficiency while providing desirable implementation size and heat dissipation characteristics.

While FIG. 8 shows the PMC 812 coupled only with the baseband circuitry 804. However, in other embodiments, the PMC 812 may be additionally or alternatively coupled with, and perform similar power management operations for, other components such as, but not limited to, application circuitry 802, RF circuitry 806, or FEM 808.

In some embodiments, the PMC 812 may control, or otherwise be part of, various power saving mechanisms of the device 800. For example, if the device 800 is in an RRC_Connected state, where it is still connected to the RAN node as it expects to receive traffic shortly, then it may enter a state known as Discontinuous Reception Mode (DRX) after a period of inactivity. During this state, the device 800 may power down for brief intervals of time and thus save power.

If there is no data traffic activity for an extended period of time, then the device 800 may transition off to an RRC_Idle state, where it disconnects from the network and does not perform operations such as channel quality feedback, handover, etc. The device 800 goes into a very low power state and it performs paging where again it periodically wakes up to listen to the network and then powers down again. The device 800 may not receive data in this state, in order to receive data, it can transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 802 and processors of the baseband circuitry 804 may be used to execute elements of one or more instances of a protocol stack. For example, processors of the baseband circuitry 804, alone or in combination, may be used to execute Layer 3, Layer 2, or Layer 1 functionality, while processors of the application circuitry 804 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 9 illustrates example interfaces of baseband circuitry in accordance with some embodiments. As discussed above, the baseband circuitry 804 of FIG. 8 may comprise processors 804A-804E and a memory 804G utilized by said processors. Each of the processors 804A-804E may include a memory interface, 904A-904E, respectively, to send/receive data to/from the memory 804G.

The baseband circuitry 804 may further include one or more interfaces to communicatively couple to other circuitries/devices, such as a memory interface 912 (e.g., an interface to send/receive data to/from memory e8ernal to the baseband circuitry 804), an application circuitry interface 914 (e.g., an interface to send/receive data to/from the application circuitry 802 of FIG. 8), an RF circuitry interface 916 (e.g., an interface to send/receive data to/from RF circuitry 806 of FIG. 8), a wireless hardware connectivity interface 918 (e.g., an interface to send/receive data to/from Near Field Communication (NFC) components, Bluetooth® components (e.g., Bluetooth® Low Energy), Wi-Fi® components, and other communication components), and a power management interface 920 (e.g., an interface to send/receive power or control signals to/from the PMC 812.

### FIG. 10: Network Architecture Supporting AI/ML

FIG. 10 illustrates an example architecture of a system 1000 supporting artificial intelligent (AI) including open radio access network (O-RAN) in accordance with some embodiments. The system 1000 includes a radio access network (RAN) 1002 and a core network 1004 interconnected through logical interfaces.

The RAN 1002 provides radio connectivity between user equipment (UEs) (e.g., UE 106) and the core network 1004. The RAN 1004 may be provided by a BS 102 which interfaces with a UE 106 over a radio interface to provide connectivity and mobility management.

The RAN 1002 may include a distributed unit (DU) 104 which hosts lower layer radio interface protocols including PDCP and RLC.

The RAN 1002 may include a centralized unit (CU) which hosts higher layer radio protocols. The CU is split into a control plane (CU-CP) 1012 hosting radio resource control (RRC) messaging and a user plane (CU-CP) 1014 hosting a Service Data Adaption Protocol (SDAP) and Packet Data Convergence Protocol (PDCP) layers. The CU-UP 1012 also performs AI/ML model training and inference.

The RAN 1002 may include a non-real-time RAN intelligent controller (RIC) 1008 (which may be a software entity, a computer system and/or server, such as server 104) and a near real-time RIC 1010, as well as various other functions and/or entities. The Non-real-time RIC 1008 may control functionality at periods of greater than 1 second whereas the near-real-time (near-RT) RIC 1010 may control RAN functionality at periods of less than 1 second. In some embodiments, trained models and real-time control functions produced in the non-real-time RIC 1008 may be distributed to the near-real-time RIC 1010 for runtime execution. In other words, in some embodiments, the non-real-time RIC 1008 may be a logical function that enables non-real-time control and optimization of RAN elements and resources, AI/ML workflow including model training and updates, and policy-based guidance of applications/features in the near-real-time RIC 1010.

The core network 1004 may include an access and mobility management function (AMF) 1032 for access control and mobility management, a user plane function (UPF) 1034 forwarding user data, a unified data management (UDM) 1046 for managing subscriber data, policies, and/or authorization, a session management function (SMF) 1036 for session establishment and modification, a data collection and consolidation function (DCCF) 1044 that aggregates data from the UE 106 and the RAN 1002 for AI/ML model training, an AI data repository function (ADRF) 1042 to store the aggregated data for AI/ML, a network data analytics function (NWDAF) 1050 that performs analytics on aggregated data, and a transcoding entity (TCE) 1048 for media transcoding.

An “over-the-top” (OTT) server 1060 is also depicted that is in association with the UPF 1034 and the CU-UP 1014 and may provide applications and services directly over the internet to the UE 106.

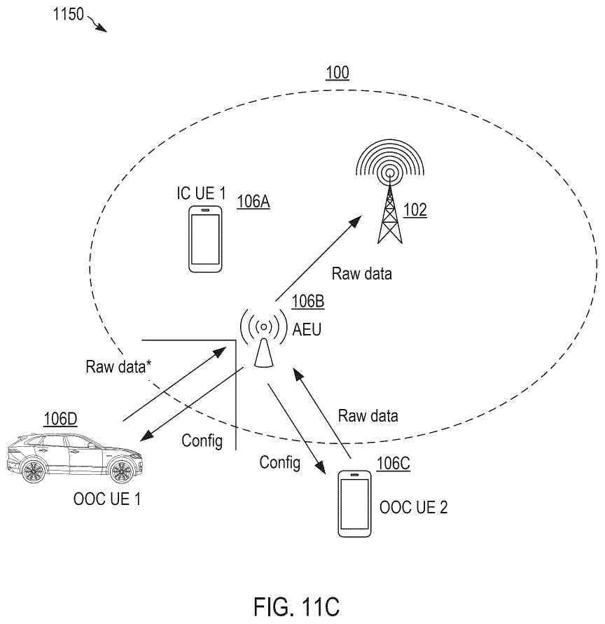

### FIGS. 11A-C: AI/ML Edge User Equipment Block Diagrams

FIGS. 11A-B illustrate examples of AI/ML edge user equipment (AEU) 106b deployed to enhance AI/ML performance using sidelink connections. In future wireless networks, such as a sixth generation cellular network, the AEU (e.g., AEU 106B) is a type of user equipment (UE) called an AI/ML Edge UE (AEU) that is designed to improve AI/ML performance within the cellular network. The AEU 106B can be a dedicated new UE with AI/ML capabilities, or an existing network device such as, for example, a repeater, an integrated access and backhaul (IAB) node, or reconfigurable and intelligent surface (RIS) node enhanced with AI/ML functionality. The AEU 106B may collect raw data from nearby out-of-coverage (OOC) UEs and report the data to a network (e.g., base station 102). The AEU 106B may forward AI/ML models from the network to OOC UEs to enable collaborative network-UE AI/ML. The AEU 106B may perform localized training and inference using data from nearby OOC UEs and in-coverage (IC) UEs, then report the results to the network. Additionally, the AEU 106B may support multi-vendor AI/ML training and inference for nearby UEs with different radios (e.g. UEs with wireless local area network (WLAN) connections, such as IEEE 802.11 Wi-Fi direct connections), but no cellular radios.

Turning now to FIG. 11A, FIG. 11A depicts a diagram of a system 1100 that includes an AI/ML Edge UE (AEU) 106B that establishes a connection to a base station 102 providing connectivity to a core network (e.g., 1004 in FIG. 10). The AEU 106B may establish one or more peer to peer connections with multiple user equipments (UEs) such as, for example, out of coverage (OOC) UE1 (e.g., UE 106D), OOC UE 2 (e.g., UE 106C) and one or more in-coverage UEs, such as UE 1 (e.g., UE 106A).

As used herein, out of coverage refers to a UE that is not connected to a base station, such as the base station 102. The OOC UE may not be able to connect to the BS 102 due to transmission power limitations (e.g. the UE is located beyond the range of the BS). However, the OOC UE also may not be capable of connecting to the BS. For example, the OOC UE may be configured to operate with a different mobile network operator (MNO) or may not have a cellular radio capable of connecting to the BS 102.

The AEU 106B may have a connection to a 6G RAN of the base station 102 for control signaling, along with peer to peer connections to nearby UEs (e.g., UE 106C-D) using various technologies such as, for example 5G PC5, Wi-Fi, Bluetooth, etc. The AEU can be used to enhance the use of AI/ML near the edge of wireless cellular networks. The AEU 106B can discover and be discovered by nearby UEs to determine if the AEU 106B can assist with edge AI/ML processing. New multi-radio, multi-vendor discovery procedures and AI/ML-aware AEU selection are introduced. New messages and procedures between the AEU 106B and the base station 102 enable exchanging data, models, and training/inference results to support collaborative AI/ML with UEs. Thus, the AEU 106B extends AI/ML capabilities to edge devices and augments network-based AI/ML through intelligent sidelink utilization.

Also, as used herein, a peer to peer connection may refer to a direct wireless connection between two user equipments without going through a base station 102. Examples of peer to peer connections include WLAN direct connections or other types of connections that utilize short-range wireless technologies such as, for example, a sidelink connection, a 5G PC5 connection, an F1 interface, a Wi-Fi connection, a backhaul link, or a Bluetooth connection to establish direct links between an AEU and other UEs for collaborative AI/ML. A sidelink connection is a Device-to-Device (D2D) communication technology developed by the 3GPP. A 5G PC5 is a cellular Vehicle-to-Everything connection. An F1 interface is typically used to F1 connect a BS CU to a BS DU. These examples are not intended to be limiting. A variety of different peer to peer type of wireless connections may be used to enable the AEU 106B to communicate with nearby OOC UEs 106D and IC UEs 106A. The peer to peer connections allow the AEU 106B to communicate with UEs that are beyond the coverage area of the base station 102.

It should be noted that current L2/L3 sidelink relay user equipments (UEs) simply forward data and are not aware of the actual content. Thus, these UE's cannot support the local/edge AI/ML training and inference operations proposed for the AEU 106B. In contrast, the AEU 106B can perform model training and inference at the edge using data from surrounding UEs. The AEU 106B may select appropriate UEs for model training and transfer learning. The AEU 106B can also establish data/model exchange configurations between OOC and in-coverage (IC) UEs based on network inputs. This localized edge AI/ML approach of the AEU 106B can alleviate handset restrictions and capture unique environment observations.

Thus, the AEU 106B may establish various peer to peer connections with nearby user equipment(s) (UEs). Different peer to peer communication options provide flexibility and support connectivity for diverse use cases with the AEU 106B. The different peer to peer communication options may include F1 links similar to an Integrated Access and Backhaul (IAB) that can be used for backhaul and control. The AEU 106B may establish Wi-Fi connections to allow the AEU 106B to leverage existing Wi-Fi networks and capabilities. The AEU 106B may establish Bluetooth connections to provide short-range options for the AEU 106B to connect with nearby devices. The AEU 106B can act as a backhaul for reconfigurable intelligent surfaces (RIS) by offloading tasks over their peer to peer connections. The AEU 106B may also establish Near-field communication (NFC) and ultra-wideband (UWB) connections to allow proximity-based interactions.

FIG. 11B depicts the AEU 106B collecting raw data from one or more out-of-coverage UEs (e.g., UE 106C and 106D) over one or more WLAN (e.g. peer to peer) connections, such as Wi-Fi direct or another type of P2P connection. In one aspect, the AEU 106B collects raw data from OOC UE 106D over a sidelink connection and collects raw data from OOC UE 106C over one or more different sidelink connections. The AEU 106B can aggregate and analyze the raw data from multiple UEs and transmit the results to the core network over a connection with the base station 102. This allows useful data gathering by the AEU 106B from UEs that the network cannot directly connect to.

In this way, the sidelinks allow raw data collection from user equipments (UEs) that are out-of-coverage (OOC) from the network. Since OOC UEs cannot report collected data to the network directly, a peer to peer connection to the AEU 106B provides an alternate path. The peer to peer connections can extend network-UE AI/ML collaboration to OOC UEs, which otherwise can only perform on-device AI/ML when disconnected from the cellular network.

Also, a peer to peer connection, such as sidelink, enables the AEU 106B to perform local training and inference over the sidelink at the edge of the base station 102 and can offload processing from the network. Additionally, edge sidelink training mitigates privacy concerns of UEs sharing raw data to the network since data can stay locally at the AEU.

The peer to peer connections enable the AEU 106B AI/ML collaboration between UEs with different radios and vendors. For example, one UE (e.g., UE 106D may use 5G PC while the other UE (e.g., UE 106C) can be configured to use a Wi-Fi radio. Alternatively, the UE 106D and UE 106C may have cellular radios that are configured for different MNOs, such as, from Vendor A and Vendor B, or may be UEs produced by different vendors, such as Apple or Google. The peer to peer connection enables the AEU 106B to be provide multi-vendor AI/ML capabilities.

In one example, as depicted in FIG. 11C, due to privacy reasons, the UEs 106A, 106C, 106D may not disclose certain information such as, for example, identification data (IDs) and associated data collection that is shared with a BS 102. As such, prior to data collection, the BS 102 can send a measurement configuration to the AEU 106B specifying the type of data needed for training without including any UE IDs, such as anonymized location or area activity information. The AEU 106B may include information that this data type will be collected in its peer to peer broadcast to discover UEs (e.g., UE 106A, UE 106C, and/or UE 106D), which can provide the desired data. The AEU 106B can establishes peer to peer links with responding UEs, collect the specified data, and send aggregated/anonymized results to the BS 102 without any UE IDs. If model training occurs at the BS 102, the AEU 106B can relay a trained model to the corresponding UEs without revealing their identities. This allows private data collection from UEs for AI/ML purposes.

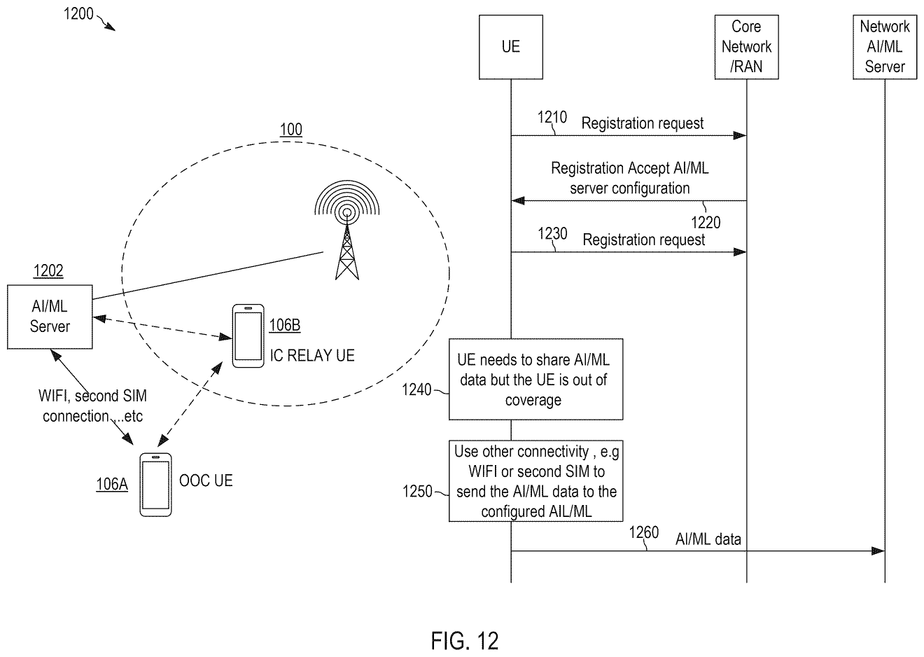

### FIG. 12: Signaling for 6G AI/ML Network Enhancement

FIG. 12 illustrates an example of signaling 1200 for enabling a 6G AI/ML network enhancement with peer to peer connections. That is, FIG. 12 illustrates an example signaling for enabling AI/ML model transfer to an out-of-coverage user equipment (OOC UE) 106A via a secondary connectivity.

The signaling 1200 shown in FIG. 12 may be used in conjunction with any of the systems, methods, and/or devices. In various embodiments, some of the signaling shown may be performed concurrently, in a different order than shown, or may be omitted. Additional signaling may also be performed as desired. As shown, this signaling may flow as follows as one example embodiment.

At 1210, the signaling may begin with an initial registration or mobility procedure between a UE (e.g., 106A and the core network/RAN 1000.

In step 1220, the core network/RAN 1000 can respond with a registration accept message providing configuration information for an AI/ML Server. This configuration information includes parameters such as, for example, an internet protocol (IP) address and security credentials for connecting to the AI/ML Server 1202.

In step 1230, the OOC UE 106A sends a registration complete message, storing the AI/ML Server configuration information for future use. Thus, as in step 1220, when the OOC UE 106A subsequently loses coverage from the core network/RAN 1000, the OOC UE 106A can establish, as in step 1230, a secondary connectivity to the network AI/ML server 1202 based on the stored configuration. This secondary connectivity can be over a peer to peer connection, such as a WLAN connection or using a second subscriber identity module (SIM) if the device has dual SIM capabilities.

Later in step 1240, when the OOC UE 106A needs to share AI/ML data but does not have coverage with the core network/RAN 1000, the OOC UE 106A can establish, as in step 1250, secondary connectivity to the AI/ML Server 1202 using a WLAN connection, such as those previously discussed, or a second SIM based on the stored configuration.

In step 1260, the OOC UE 106A can utilize the secondary connectivity to exchange AI/ML data with the network AI/ML Server 1240 while out-of-coverage from the core network/RAN 1000. Thus, the OOC UE 106A utilizes the secondary connectivity to exchange AI/ML data, models, training results, or inferences with the network AI/ML server 1240 while out-of-coverage from the core network. This allows the OOC UE 106A to collaborate on AI/ML tasks remotely over the secondary connectivity until it restores coverage with the core network/RAN 1000.

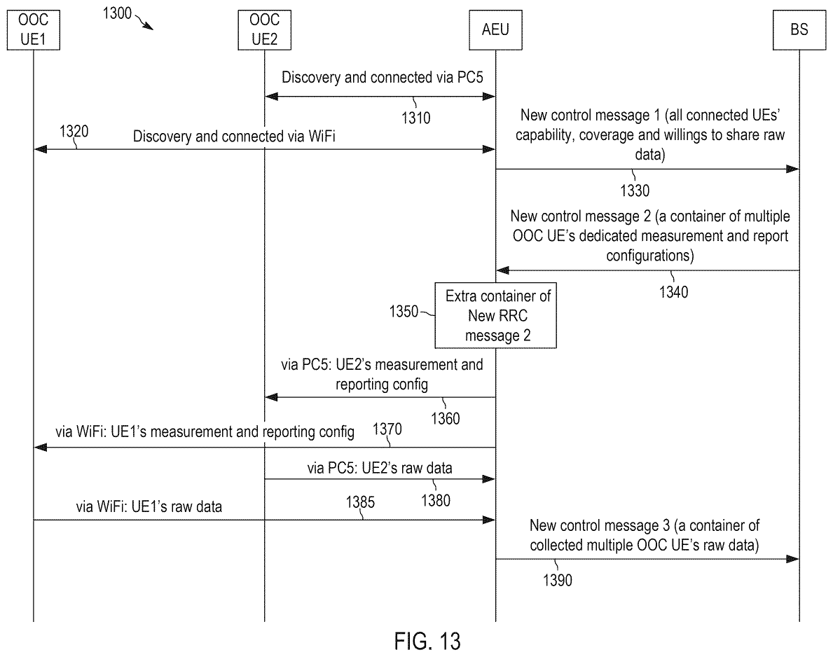

### FIG. 13: Timing Diagram for AEU Control Signaling

FIG. 13 illustrates an example timing diagram signaling 1300 between a user equipment (UE), AI/ML edge user equipment (AEU), and BS, for supporting 6G AI/ML network enhancement with peer to peer connection according to some embodiments. The signaling 1300 shown in FIG. 13 may be used in conjunction with any of the systems, methods, and/or devices. In various embodiments, some of the signaling shown may be performed concurrently, in a different order than shown, or may be omitted. The present example uses OOC UEs, but this is not intended to be limiting. In some embodiments, IC UEs may also communicate with the AEU. Additional signaling may also be performed as desired. As shown, this signaling may flow as follows.

FIG. 13 illustrates an example signaling flow between an OOC user equipment (UE), an AI/ML edge user equipment (AEU), and a BS 102 to support AI/ML enhancement using peer to peer communication.

At 1310, the signaling may be begin with an AEU performing discovery and establishes a PC5 connection, or another desired type of peer to peer connection, with OOC UE2.

In step 1320, the AEU establishes a peer to peer connection (e.g., a Wi-Fi connection) with OOC UE1 after discovery.

In step 1330, the AEU sends a first control message (e.g., a new control message 1) to the BS indicating capabilities, coverage, and the willingness to share data of its connected UEs (e.g., OOC UE 1 and/or OOO UE 2). The OOC UEs may be preconfigured as willing or unwilling to share certain types of raw data that may be used by for AI/ML. Alternatively, a user may be prompted during the discovery procedure as to whether the user wants to share the data.

In step 1340, the BS sends a second control message (e.g., a new control message 2) to the AEU containing measurement and reporting configurations for one or more UEs (e.g., OOC UE 1 and/or OOO UE 2), which may be included in a container. The container may be an extra container 1350 for containing the second control message and can include the UE configurations.

In step 1360, the AEU forwards to the OOO UE 2 measurement and reporting configuration over a peer to peer connection (e.g., PC5).

In step 1370, the AEU forwards to the OOO UE 1 measurement and reporting configuration over a peer to peer connection (e.g., Wi-Fi).

In step 1380, the OOO UE 2 sends raw data to the AEU over the peer to peer connection (e.g., PC5). In step 1385, the OOO UE 1 sends raw data to the AEU over the sidelink (e.g., Wi-Fi sidelink). The AEU may aggregate the received raw data from the UEs. In step 1390, the AEU sends the aggregated raw data to the BS in a new control message (e.g., a third control message).

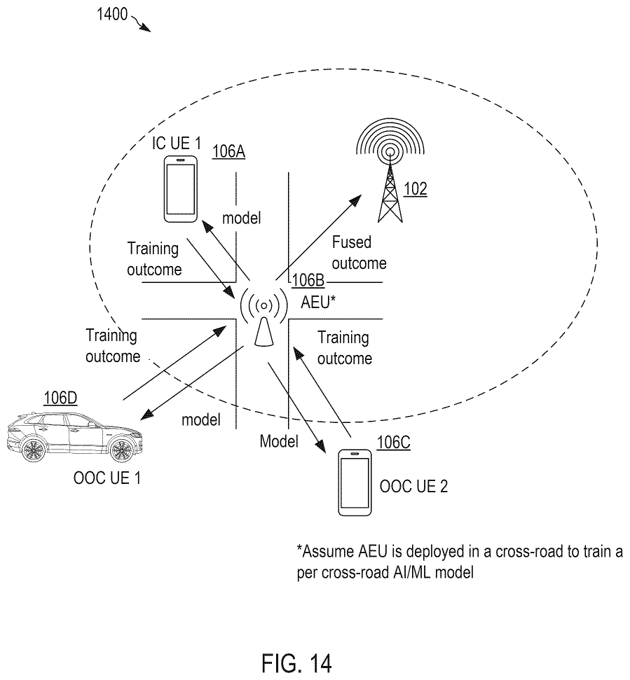

### FIG. 14: Block Diagram for Local Training/inference for AI/ML Offloading

FIG. 14 illustrates an example of system 1400 of an AEU performing local training and inference using data from nearby out-of-coverage (OOC) and in-coverage (IC) user equipment to offload the AI/ML from the network. In one example, the AEU 106B can conduct AI/ML training and inference locally using data from UEs 106A, 106C, 106D. This offloads processing work from the network. The AEU 106B may perform localized training and inference for AI/ML models and reduce privacy concerns of UEs sending raw data across the network. The AEU 106B may have greater computing capabilities than the UEs for performing training/inference and the individual UEs (e.g., UEs 106A, 106C, 106D) may lack robust AI/ML support. The training of different UEs on correlated data can produce redundant outcomes. The AEU 106B can fuse results by training/inferencing on aggregated data from multiple UEs 106A, 106C, 106D. Thus, the AEU 106B can leverage its edge location and peer to peer connections to UEs 106A, 106C, 106D in order to intelligently perform localized AI/ML processing for training and inference of AI/ML models. This delivers benefits such as reduced network burden, better privacy, and improved AI/ML model accuracy. It should be noted, by way of example only, the AEU 106 may be an AEU deployed in a cross-road to train a per cross-road AI/ML model (e.g., the AEU can collect all information data related to a cross-road (e.g. traffic), and use the collected data to train an AI model to improve peer-to-peer performance.).

To further illustrate, in one embodiment the AEU 106B may coordinate collaborative edge-based AI/ML training and inference by interfacing between the BS 102 and connected UEs 106A, 106C, 106D via the use peer to peer connections between the AEU 106B and one or more UEs 106A, 106C, 106D. The peer to peer connections may be the same type of connections, or different connections, as discussed herein. The AEU 106B may establish one or more peer to peer connections with nearby out-of-coverage UEs 106C-D and in-coverage UE 106A through a discovery procedure.

The BS 102 can configure the AEU 106B to report information about its connected UEs including their coverage status and willingness for local AI/ML processing. Based on the AEU's report, the BS 102 can send AI/ML models to the AEU 106B using alternatives such as, for example, a transparent container in RRC signaling, L1/L2 signaling, or L3 signaling from an edge server.

The AEU 106B can forward the AI/ML model received from the BS 102 to each connected UE 106A, 106C, 106D within a transparent container in sidelink signaling. Each UE 106A, 106C, 106D can perform local training on the AI model and report the training results back to the AEU 106B in a peer to peer signaling transparent container. The AEU 106B can aggregate the local training results from the UEs and send a fused model update to the BS 102.

In accordance with one embodiment, new RRC-based control messages are defined to enable signaling between the BS and AEU (e.g., from the AEU to a BS) for AI/ML coordination. These new control messages can alternatively be implemented using other Layer 2 or Layer 3 (L2/L3) protocols. The first new message (e.g., new control message 1 of FIG. 13) from the AEU to the BS can be used to indicate one or more of the capabilities of the UEs that are connected to the AEU, including: a UE identifier, UE coverage status (in or out of coverage), peer to peer connection type (e.g. PC5, Wi-Fi, BT, etc.), an indication of a willingness to share data, or an indication of a willingness for UE-Network AI/ML collaboration.

The second new message (e.g., new control message 2 of FIG. 13) from the BS to the AEU can contain one or more of configuration information for the connected UEs, including: containers with UE-specific data collection and reporting configurations, and containers with AI/ML models.

The third new message (e.g., new control message 3 of FIG. 13) from the AEU to the BS can be used to report data and AI/ML results, including: one or more of containers with collected raw data per UE, containers with training and inference outcomes per UE, or aggregated/fused training and inference outcomes. The new RRC-based control message signaling enables the AEU to coordinate AI/ML processing at the edge by interfacing between the BS and sidelink-connected UEs.

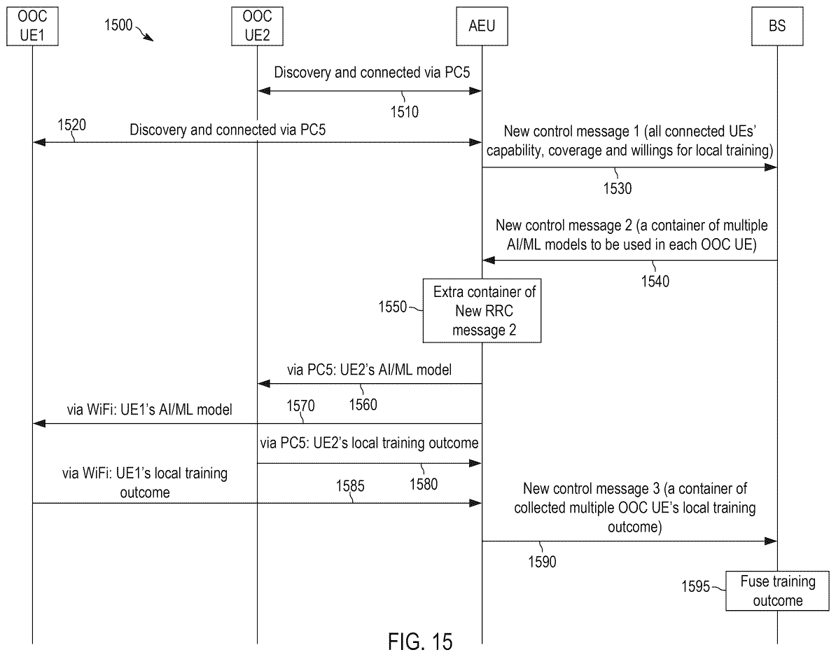

### FIG. 15: Timing Diagram for AEU Control Signaling for AI/ML Model Training

FIG. 15 illustrates a timing diagram signaling 1500 illustrating an AEU selection procedure that supports AI/ML network enhancement using peer to peer connections in accordance with some embodiments. In other words, the timing diagram 1500 depicts a process for selecting an AEU that supports AI/ML network enhancement using peer to peer connections. The signaling 1500 shown in FIG. 15 may be used in conjunction with any of the systems, methods, and/or devices. In various embodiments, some of the signaling shown may be performed concurrently, in a different order than shown, or may be omitted. Additional signaling may also be performed as desired. As shown, this signaling may flow as follows.

At 1510, the signaling can begin with the AEU performing discovery over a peer to peer connection (e.g., PC5) and establishing a bi-directional PC5 connection with a target UE (e.g., OOC UE2).

At 1520, the AEU can perform a discovery over a peer to peer connection (e.g., Wi-Fi) and establish a bi-directional Wi-Fi connection with an additional target UE (e.g., OOC UE1).

At step 1530, the AEU can send a first new control message (e.g., new control message 1) to the BS indicating the capabilities, coverage, and willingness for local training of the connected OOC UE (OOC UE1 and OOC UE2).

At step 1540, the BS can send a second new control message (e.g., new control message 2) to the AEU containing AI/ML models for each connected OOC UE (OOC UE 1 and OOC UE 2) within containers. The containers may be an extra container 1550 for containing the second control message and includes the UE configurations.

At step 1560, the AEU can forward the AI/ML model for OOC UE 2 over the PC5 connection to OOC UE 2.

At step 1570, the AEU can forward the AI/ML model for OOC UE 1 over the Wi-Fi connection to OOC UE 1.

At step 1580, OOC UE 2 can perform local training on its AI/ML model received in step 1560 and send the training outcome over the PC5 connection back to the AEU.

At step 1585, OOC UE 1 can perform local training on its AI/ML model received in step 1570 and send the training outcome over the Wi-Fi connection to the AEU.

At step 1590, the AEU can aggregate the local training outcomes from OOC UE 1 and OOC UE 2 and sends the aggregated local OOC UE training outcome in a third new control message (e.g., new control message 3) to the BS. At step 1595, the BS can fuse the training outcome results.

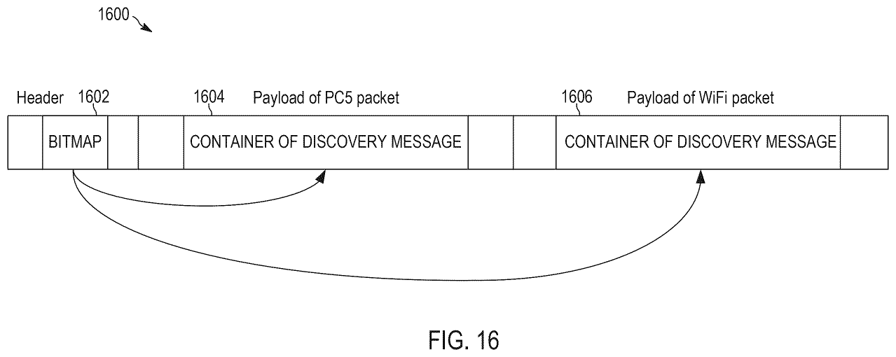

### FIG. 16: Generic Discovery Message for Multiple Peer to Peer Links

FIG. 16 illustrates an example of a discovery message 1600 for multi-radio, multi-vendor AI/ML aware discovery in accordance with some embodiments.

The ability of the AEU 106B to connect to multiple UEs, such as OOC UEs, using different types of peer to peer communications, can complicate signaling between the AEU and the different UEs. In one example, a container can be used to enable an AEU to send discovery information via different types of peer to peer data links with nearby UEs. This discovery information can be used by the UEs to select an AEU.

In one example, the discovery message 1600 may be specified as an Extensible Markup Language (XML) file or similar radio-independent file format. The discovery message 1600 may be transmitted within a container inside a payload of packets sent over different radio links such as, for example, PC5, Wi-Fi, etc. In one embodiment, the discovery message itself may be decoupled or separated from the radio technology used to transmit it. For example, the same discovery message can be sent over PC5 and Wi-Fi, rather than having two separate radio-specific discovery messages. Thus, a radio-independent discovery message is provided that contains key discovery information but is not tied to any specific radio technology. The discovery message (e.g., a radio-independent discovery message) can then be transmitted over different radios such as, for example, PC5, Wi-Fi, etc. without changes. The discovery message is decoupled or separated from the underlying radio used.

In one example, a header 1604 of the packet includes a bitmap indicating whether the payload contains a discovery message and if so, where it is located. For example, the bitmap indicating a payload of a PC5 packet in a first container of discovery message 1604 and a payload of a Wi-Fi packet in a second container of discovery message 1606.

The discovery message 1600 itself can include information such as: 1) whether a UE supports data forwarding, 2) whether the UE supports AI/ML model training offloading, including supported models, features, formats etc., 3) whether the UE supports AI/ML model inference offloading, including supported models, features, formats etc., and, 4) any remaining available AI/ML compute resources such as, for example, floating operations per second (FLOPs). This allows the discovery message to exchange radio-independent AI/ML capabilities to enable multi-radio, multi-vendor discovery between devices like the AEU and UEs.

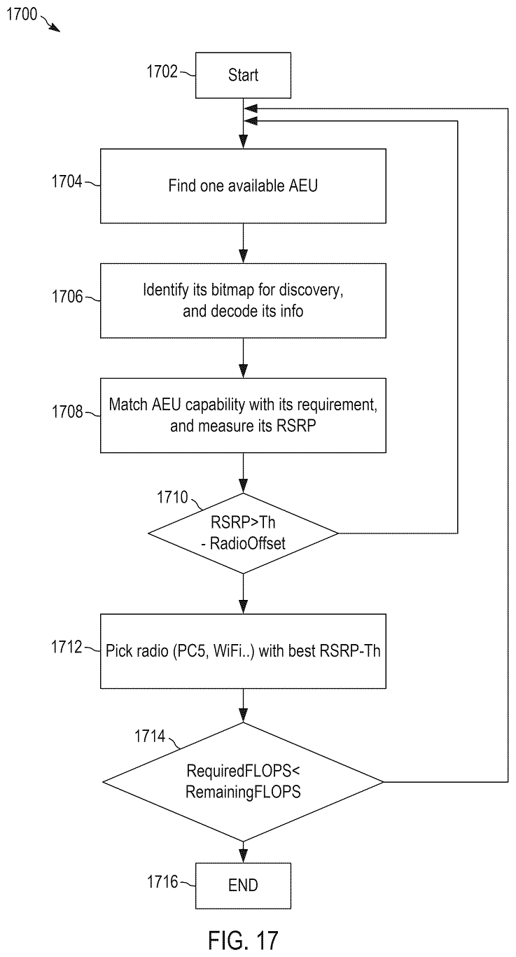

### FIG. 17: Block Diagram for AEU Discover Procedure

In one embodiment, a UE can be configured to select an AEU. The UE can select the AEU based on a number of considerations, including a wireless link quality with the AEU, the processing power of the AEU, the amount of spare processing power of the AEU, the signal strength of the AEU with a BS, and so forth. FIG. 17 illustrates an example of a method 1700 for performing an AEU selection procedure by a UE to support multi-radio, multi-vendor AI/ML aware discovery according to some embodiments. The method 1700, illustrated in the example of FIG. 17, may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

In one embodiment, the method 1700 depicts the process for selecting an AEU to support multi-radio, multi-vendor AI/ML aware discovery. In this way, selecting the AEU can prevent UE greedy behavior that can overload a single AEU, while also supporting radio selection for coverage vs load balancing tradeoffs.

In this example, the method 1700 can start at 1702, wherein a UE can attempt to find and/or locate one or more available AEUs, as in step 1704. At step 1706, the UE can identify the AEU's discovery bitmap and decode the discovery information, as previously discussed with respect to FIG. 16. At step 1708, the UE can match the discovered AEU capabilities against the UE's own requirements and measure a reference signal, such as a received signal received power (RSRP) of the AEU. At step 1710, the UE can determine whether the AEU's RSRP exceeds a configured RSRP threshold radio offset. If not, the method 1700 returns to step 1704, at which point the UE can search for another AEU with desired attributes. At step 1712, the UE can select the AEU radio if the AEU's RSRP exceeds the configured RSRP threshold radio offset. At step 1714, the UE can determine whether the AEU's remaining AI/ML FLOPs are greater than desired FLOPs. If so, the UE can select this AEU. If not, the method 1700 returns to step 1704 and the UE can search for another AEU with desired attributes. At step 1716, the method ends.

In one embodiment, as described in FIG. 17, a network can preconfigure an RSRP offset value for each radio as a baseline for comparison. This can account for differences in radio coverage and network preferences. The UE can search for potential AEU candidates and evaluate their AI/ML capabilities and remaining compute resources. The UE can match the AEU capabilities against its own requirements. The UE can measure the RSRP of each potential AEU. The UE can select an AEU if its RSRP exceeds the preconfigured RSRP threshold minus the radio-specific offset. This can ensure adequate coverage. Based on the AEU radios meeting the RSRP criteria, the UE can select the AEU with remaining FLOPs greater than the desired FLOPs. This can be used to ensure compute resource availability. Finally, if multiple suitable AEUs are found, the UE can either select the one with maximum remaining FLOPs or the first suitable AEU. In summary, this example can be used to enable a UE to carefully evaluate AEUs based on coverage, load balancing, and resources to prevent overload of any one AUE and ensure AI/ML performance. The network can influence selection via RSRP offsets.

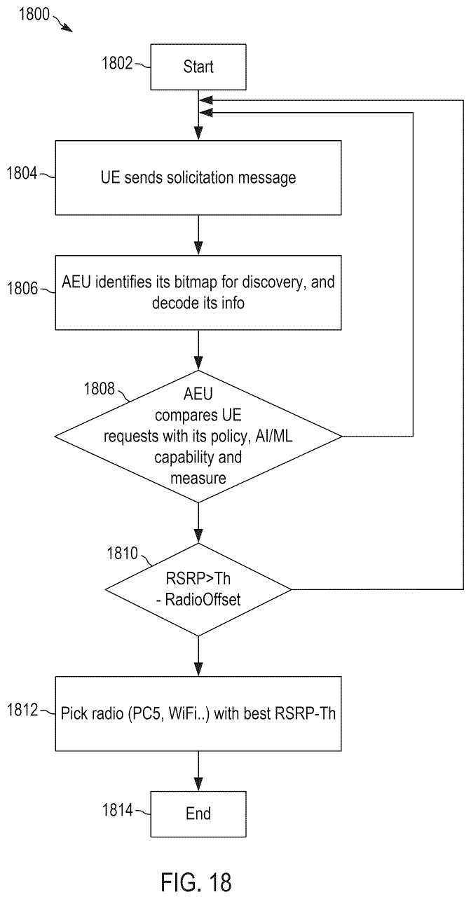

### FIG. 18: AEU Selection Procedure

FIG. 18 provides an example procedure for performing an AEU selection to support multi-radio, multi-vendor AI/ML aware discovery from the AEU perspective, according to some embodiments. The method 1800, illustrated in the example of FIG. 18, may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

The method 1800 starts at 1802. In this example, a UE can send a solicitation message for one or more potential AEU candidates, as in step 1804.

At step 1806, an AEU can receive the message from the UE and identify the UE's discovery bitmap and decode the information to determine the UE's capabilities.

At step 1808, the AEU can evaluate and compares the UE's capabilities against the AEU's own policy, AI/ML capabilities, and measure whether the AEU can provide the services desired by the UE.

At step 1810, the AEU can determine whether the UE's RSRP exceeds a configured RSRP threshold radio offset. If not, the method 1800 returns to step 1804 at which point the UE can send another solicitation message.

At step 1812, the AEU can select the UE radio with a strongest RSRP out of the qualified UE set. At step 1814, the method 1800 may end.

Thus, as described in FIG. 18, in one embodiment, a new procedure is provided for AEU selection for AI/ML offloading. Based on network policy, conditions, and AEU compute availability, the AEU can evaluate user equipment (UE) solicitation messages and select appropriate UEs for offloading. The UEs can send requests that include AI/ML model details and discovery information with capabilities (e.g., AI/ML model ID, input/output features, model format, etc.). The UE(s) may send unified, radio-independent discovery messages, as described in FIG. 16.

The AEU can admit UEs for offloading based on various conditions such as, for example, the UE's RSRP exceeds a configured threshold offset, the AEU supporting the requested model and features, and the AEU having sufficient FLOPs for the AI model.

If multiple AEUs satisfy the various conditions for a UE's offloading request, two options may be available: 1) allow the AEUs to inform the network which UEs meet the criteria, and the network can configure the specific AEU-UE pairings; or 2) the UE can select its preferred AEU and inform the AEU of its choice. This standardized procedure allows the AEU to selectively choose UEs to offload based on network guidance, AEU resources, and UE needs in order to optimize overall AI/ML performance.

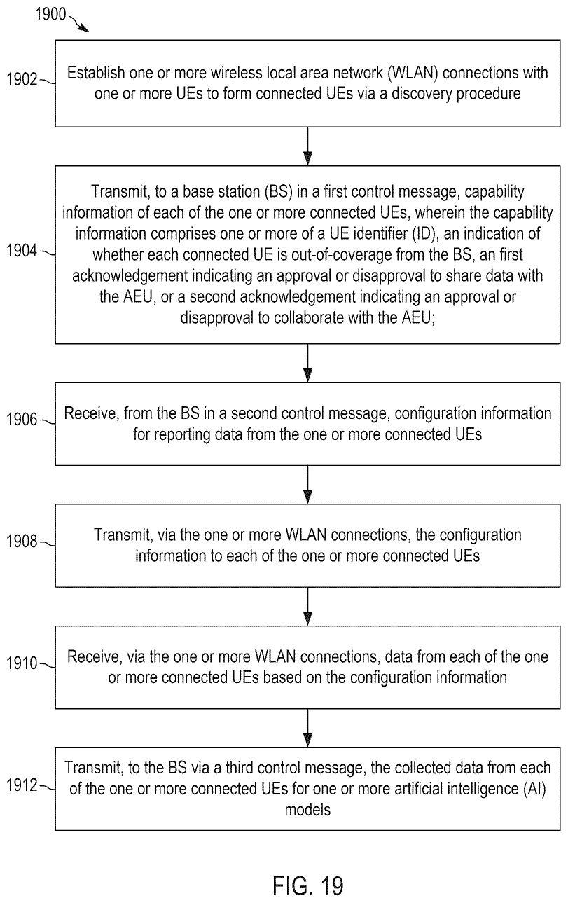

### FIG. 19: Method for Providing Enhanced AI/ML Performance

FIG. 19 illustrates an example of a method 1900 for providing enhanced AI/ML performance using peer to peer connections with an AI/ML edge user equipment (AEU) according to some embodiments. The method 1900, illustrated in the example of FIG. 19, may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At step 1902, a user equipment device (UE), such as UE 106, may establish one or more wireless local area network (WLAN) connections with one or more UEs to form connected UEs via a discovery procedure.

At step 1904, the UE may transmit, to a base station (BS) in a first control message, capability information of each of the one or more connected UEs, wherein the capability information comprises one or more of a UE identifier (ID), an indication of whether each connected UE is out-of-coverage from the BS, a first acknowledgement indicating an approval or disapproval to share data with the AEU, or a second acknowledgement indicating an approval or disapproval to collaborate with the AEU.

At step 1906, the UE may receive, from the BS in a second control message, configuration information for reporting data from the one or more connected UEs.

At step 1908, the UE may transmit, via the one or more WLAN connections, the configuration information to each of the one or more connected UEs.

At step 1910, the UE may receive, via the one or more WLAN connections, data from each of the one or more connected UEs based on the configuration information.

At step 1912, the UE may transmit, to the BS via a third control message, the collected data from each of the one or more connected UEs for one or more artificial intelligence (AI) models.

In some instances, the UE may perform the discovery procedure by: transmitting a discovery message to the one or more UEs, wherein the discovery message includes the AEU identifier and AEU capability information; receiving a discover message response from the one or more UE's to establish the WLAN connections based on the discovery message; transmitting to the one or more UEs a connection setup request based on the discover message response; receiving a connection setup request response from the one or more UEs based on the connection setup request to establish the WLAN connection; and/or storing, at the AEU, the capability information of received from each of the one or more connected UEs.

In one aspect, the WLAN connections include one or more of various radio access technologies (RAT) and one or more peer-to-peer (P2P) connections. Also, the first control message may include an indication identifying each of the one or more connected UEs connected to the AEU and a type of WLAN connections of the one or more connected UEs connected to the AEU. The second control message may include 1) a first transparent container including the configuration information, that includes data collection and reporting configuration information, for each of the one or more connected UEs, and 2) a second transparent container including one or more AI models.

In some instances, the UE may receive, from the BS in the second control message, the configuration information via at least one of a radio resource control (RRC) message, a layer 1 (L1) signaling, a layer 2 (L2) signaling, or layer 3 (L3) signaling. In some instances, the UE may receive, from the BS in the second control message, one or more AI models for local training and inference for each of the one or more connected UEs.

In one example, the third control message may include a first transparent container including the data received from each of the one or more connected UEs connected to the AEU based on the configuration information, a second transparent container including AI model training results based on the data from each of the one or more connected UEs, a third transparent container including AI model inference results based on the data from each of the one or more connected UEs, a fourth transparent container including aggregated AI model training results obtained by combining each of the AI model training results and the AI model inference results from each of the one or more connected UEs; and/or a fifth transparent container including an aggregated inference outcome obtained using the aggregated AI model training results.

In some instances, the UE may establish a network connection with a base station (BS); establish one or more peer to peer or WLAN connections with one or more user equipments (UEs) to form connected UEs that are out-of-coverage from the BS; transmit, to the BS in a first control message, capability information of each of the one or more connected UEs, where the capability information comprises one or more of a UE identifier (ID), an indication of whether each connected UE is out-of-coverage from the BS, an first acknowledgement indicating an approval or disapproval to share data with the AEU, or a second acknowledgement indicating an approval or disapproval to collaborate with the AEU; receive, from the BS in a second control message, one or more AI models for local training and inference; transmit, via the one or more peer to peer or WLAN connections, the one or more AI models to each of the one or more connected UEs; receive, via the one or more peer to peer or WLAN connections, local training or inference results from each of the one or more connected UEs; aggregate the local training or inference results from the one or more connected UEs; and transmit, to the BS via a third control message, aggregated results from the additional local training or inference. The peer to peer or WLAN connections include one or more of various radio access technologies (RAT) and one or more peer-to-peer (P2P) connections.

In one example, the first control message further comprises an indication identifying each of the one or more connected UEs connected to the AEU and a type of peer to peer or WLAN connections of the one or more connected UEs connected to the AEU. In one example, the second control message further comprise: a first transparent container including the configuration information, that includes data collection and reporting configuration information, for each of the one or more connected UEs; and a second transparent container including one or more AI models.

In some instances, the UE may receive, from the BS in the second control message, the configuration information via at least one of a radio resource control (RRC) message, a layer 1 (L1) signaling, a layer 2 (L2) signaling, or layer 3 (L3) signaling. In some instances, the UE may receive, from the BS in the second control message, one or more AI models for local training and inference for each of the one or more connected UEs.

The third control message further comprise a first transparent container including data received from each of the one or more connected UEs connected to the AEU based on the configuration information, a second transparent container including AI model training results based on the data from each of the one or more connected UEs, a third transparent container including AI model inference results based on the data from each of the one or more connected UEs, a fourth transparent container including an aggregated AI model training results obtained by combining each of the AI model training results and the AI model inference results from each of the one or more connected UEs; and a fifth transparent container including an aggregated inference outcome obtained using the aggregated AI model training results.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) including one or more baseband processors and one or more application processors and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus of an artificial intelligence (AI) edge user equipment (AUE) configured to enhance AI network performance, the apparatus comprising:
one or more processors, coupled to a memory, configured to:
establish one or more peer to peer connections with one or more UEs to form connected UEs via a discovery procedure;
transmit, to a base station (BS) in a first control message, capability information of each of the one or more connected UEs, wherein the capability information comprises one or more of a UE identifier (ID), an indication of whether each connected UE is out-of-coverage from the BS, a first acknowledgement indicating an approval or disapproval to share data with the AEU, or a second acknowledgement indicating an approval or disapproval to collaborate with the AEU;
receive, from the BS in a second control message, configuration information for reporting data from the one or more connected UEs;
transmit, via the one or more peer to peer connections, the configuration information to each of the one or more connected UEs;
receive, via the one or more peer to peer connections, data from each of the one or more connected UEs based on the configuration information; and
transmit, to the BS via a third control message, the data from at least one of the one or more connected UEs for one or more artificial intelligence (AI) models.

2. The apparatus of claim 1, wherein the one or more processors are further configured to perform the discovery procedure by:
transmitting a discovery message to the one or more UEs, wherein the discovery message includes the AEU identifier and AEU capability information;
receiving a discover message response from the one or more UE's to establish the peer to peer connections based on the discovery message;
transmitting to the one or more UEs a connection setup request based on the discover message response;
receiving a connection setup request response from the one or more UEs based on the connection setup request to establish the peer to peer connection; and
storing, at the AEU, the capability information of received from each of the one or more connected UEs.

3. The apparatus of claim 1, wherein the peer to peer connections include one or more of various radio access technologies (RAT) and one or more wireless local area network (WLAN) connections.

4. The apparatus of claim 1, wherein the first control message further comprises an indication identifying each of the one or more connected UEs connected to the AEU and a type of peer to peer connection of the one or more connected UEs connected to the AEU.

5. The apparatus of claim 1, wherein the second control message further comprise:
a first transparent container including the configuration information, that includes data collection and reporting configuration information, for each of the one or more connected UEs; and
a second transparent container including one or more AI models.

6. The apparatus of claim 1, wherein the one or more processors are further configured to receive, from the BS in the second control message, the configuration information via at least one of a radio resource control (RRC) message, a layer 1 (L1) signaling, a layer 2 (L2) signaling, or layer 3 (L3) signaling.

7. The apparatus of claim 1, wherein the one or more processors are further configured to receive, from the BS in the second control message, one or more AI models for local training and inference for each of the one or more connected UEs.

8. The apparatus of claim 1, wherein the third control message further comprise:
a first transparent container including the data received from each of the one or more connected UEs connected to the AEU based on the configuration information;
a second transparent container including AI model training results based on the data from each of the one or more connected UEs;
a third transparent container including AI model inference results based on the data from each of the one or more connected UEs;
a fourth transparent container including aggregated AI model training results obtained by combining each of the AI model training results and the AI model inference results from each of the one or more connected UEs; and
a fifth transparent container including an aggregated inference outcome obtained using the aggregated AI model training results.

9. An apparatus of a user equipment (UE) configured to enhance artificial intelligence (AI) network performance, the apparatus comprising:
one or more processors, coupled to a memory, configured to:
transmit, to a base station (BS), a registration request;
receive, from the BS, configuration information of an artificial intelligence (AI) server;
establish one or more secondary connections to the AI server based on the configuration information when the UE is out-of-coverage from the from the BS; and
transfer, to the AI server via the secondary connectivity, at least one of AI data, an AI model, or a result of AI training or inference with the AI server.

10. The apparatus of claim 9, wherein the configuration information comprises one or more of an internet protocol (IP) address of the AI server and AI server security credentials.

11. The apparatus of claim 9, wherein the secondary connectivity comprises at least one of a wireless local area network (WLAN) connectivity or a second subscriber identity module (SIM) connectivity.

12. The apparatus of claim 9, wherein the one or more processors are further configured to:
determine the UE is disconnected to the BS; and
establish the one or more secondary connections to the AI server based on the UE being disconnected to the BS.

13. An apparatus of an artificial intelligence (AI) edge user equipment (AUE) configured to enhance AI network performance, the apparatus comprising:
one or more processors, coupled to a memory, configured to:
establish a network connection with a base station (BS);
establish one or more wireless local area network (WLAN) connections with one or more user equipments (UEs) to form connected UEs that are out-of-coverage from the BS;
transmit, to the BS in a first control message, capability information of each of the one or more connected UEs, wherein the capability information comprises one or more of a UE identifier (ID), an indication of whether each connected UE is out-of-coverage from the BS, a first acknowledgement indicating an approval or disapproval to share data with the AEU, or a second acknowledgement indicating an approval or disapproval to collaborate with the AEU;
receive, from the BS in a second control message, one or more AI models for local training and inference;
transmit, via the one or more WLAN connections, the one or more AI models to each of the one or more connected UEs;
receive, via the one or more WLAN connections, local training or inference results from each of the one or more connected UEs;
aggregate the local training or inference results from the one or more connected UEs; and
transmit, to the BS via a third control message, aggregated results from the local training or inference.

14. The apparatus of claim 13, wherein the WLAN connections include one or more of various radio access technologies (RAT) and one or more peer-to-peer (P2P) connections.

15. The apparatus of claim 13, wherein the first control message further comprises an indication identifying each of the one or more connected UEs connected to the AEU and a type of WLAN connections of the one or more connected UEs connected to the AEU.

16. The apparatus of claim 13, wherein the second control message further comprise:
a first transparent container including the configuration information, that includes data collection and reporting configuration information, for each of the one or more connected UEs; and
a second transparent container including one or more AI models.

17. The apparatus of claim 13, wherein the one or more processors are further configured to receive, from the BS in the second control message, the configuration information via at least one of a radio resource control (RRC) message, a layer 1 (L1) signaling, a layer 2 (L2) signaling, or layer 3 (L3) signaling.

18. The apparatus of claim 13, wherein the one or more processors are further configured to receive, from the BS in the second control message, one or more AI models for local training and inference for each of the one or more connected UEs.

19. The apparatus of claim 13, wherein the third control message further comprise:
a first transparent container including data received from each of the one or more connected UEs connected to the AEU based on the configuration information;
a second transparent container including AI model training results based on the data from each of the one or more connected UEs;
a third transparent container including AI model inference results based on the data from each of the one or more connected UEs;
a fourth transparent container including an aggregated AI model training results obtained by combining each of the AI model training results and the AI model inference results from each of the one or more connected UEs; and
a fifth transparent container including an aggregated inference outcome obtained using the aggregated AI model training results.

20. (canceled)

21. (canceled)

22. The apparatus of claim 13, wherein the one or more processors are further configured to collect data for the one or more AI models from the one or more connected UEs by collecting at least one of an aggregated training result from the local training or an aggregated inference result from the local inference.

23. (canceled)

24. (canceled)

25.

26. (canceled)

27. (canceled)

28. (canceled)

29. (canceled)

30. (canceled)

31. (canceled)

32. (canceled)

33. (canceled)
